(19) United States
(12) Patent Application Publication
(10) Pub. No.: US 2026/0004573 A1
(43) Pub. Date: Jan. 1, 2026

(54) METHOD AND DEVICE FOR CLASSIFYING AND LOCALISING OBJECTS IN IMAGE SEQUENCES, AND ASSOCIATED SYSTEM, COMPUTER PROGRAM AND STORAGE MEDIUM

(71) Applicant: SAFRAN, PARIS (FR)

(72) Inventor: Jennifer VANDONI, MOISSY-CRAMAYEL (FR)

(21) Appl. No.: 18/880,743

(22) PCT Filed: Jun. 30, 2023
(86) PCT No.: PCT/FR2023/051005

§ 371 Date: Jan. 2, 2025

(30) Foreign Application Priority Data
Jul. 4, 2022 (FR) 2206771

(51) Int. Cl. G06V 10/82; G06T 7/70; G06V 10/776

(52) U.S. Cl. CPC G06V 10/82; G06T 7/70; G06V 10/776; G06T 2207/20084

(57) ABSTRACT

A method and a device for classifying and localizing an object in an image sequence. The proposed method includes obtaining a sequence of one or more images captured by a camera; and determining, by a classifier-localizer module based on the obtained image sequence a class assigned to the object, the assigned class being selected from among a list of classes; and an estimated position of the object; the classifier-localizer module being configured based on reference image sequences to minimize a multi-objective loss function representative both of an objective of classification and an objective of object localization in the reference sequences.

### TECHNICAL FIELD

This invention relates to the fields of image processing and analysis, as well as to the field of computer vision. More specifically, this invention relates to a method and device for classifying and localizing objects in an image sequence, and a method for configuring an object classifier-localizer module in an image sequence, as well as an associated system, computer program and information medium. This invention has a particularly advantageous, though in no way limiting, application for the implementation of onboard systems, such as autonomous vehicles, surveillance systems or navigation systems.

### PRIOR ART

The automatic detection of objects in an optical scene is a technical problem that has been studied for many years. In particular, accurately identifying an object in images is a critical task for many applications, particularly domestic, industrial, military applications etc. The example of autonomous vehicles illustrates the importance of identifying an object in a visual scene with accuracy, particularly to prevent collisions.

Several devices exist for identifying an object. Radar systems are a common example of a device for detecting an object, The waves emitted by a radar system are reflected by an object, then received and analyzed by the radar system to detect the presence and determine the position of the object. However, radar systems have the following drawbacks. They require specific equipment, equipment which is generally bulky and expensive. Radar systems allow to detect the presence of an object and to estimate the position thereof, but the object to be detected must have certain particular physical properties. The object to be detected must reflect electromagnetic waves, which is not always the case.

It is also known to use one or more cameras to identify an object in an optical scene. For example, by making use of stereovision methods comparing two images of one and the same object taken by two cameras, it is possible to obtain an item of information about the position of an object. However, these methods require the use of several cameras simultaneously, which involves significant bulk and cost. In addition, the estimates produced by these methods in the case of distant objects do not offer satisfactory accuracy.

Moreover, the known solutions for identifying an object based on one or more cameras make use of the visual information related to the object. By way of illustration, existing methods rely on the measurement of the size of the object, while others rely on the extraction of characteristic points related to the object. The existing solutions thus require the object to be represented over several pixels in the images used. In the case of distant objects, these solutions do not allow to identify an object accurately and are not satisfactory. In addition, the accuracy of these solutions is substantially degraded by the effects of atmospheric attenuation, which are significant for distant objects.

There is consequently a need for a solution making it possible to accurately identify an object in an optical scene, even for a distant object.

### SUMMARY OF THE INVENTION

The aim of this invention is to remedy all or part of the drawbacks of the prior art, particularly those described previously.

For this purpose, according to an aspect of the invention, a method for classifying and localizing at least one object in an image sequence is proposed, said method comprising steps of:
obtaining a sequence of one or more images captured by at least one camera; and
determining, by a classifier-localizer module based on the obtained image sequence:
   at least one class assigned to said at least one object, said at least one assigned class being selected from among a list of assignable classes; and
   at least one estimated position of said at least one object.

The classifier-localizer module used is configured based on at least one reference image sequence to minimize a multi-objective loss function representative both of an objective of classification and an objective of localization of objects in said at least one reference sequence.

The term “image” here refers to a set of computer data representative of an optical scene.

The term “position of an object” here refers to an absolute or relative position of an object present on an image. The term “absolute position” should be understood to mean a position defined with respect to the terrestrial reference frame (e.g. geographical coordinates). In the context of the invention, a relative position is a position defined with respect to an observer position (e.g. a distance between the object and a camera) or with respect to a preceding position of the object itself (e.g. a displacement of the object, a speed). It should be noted that, according to an embodiment, the proposed method determines an absolute position of an object based on the obtained image sequence and on the position (e.g. geographical coordinates) of the device implementing the method.

The term “loss function” here refers to a function to be minimized during the configuration of a module or of its parameters.

The term “reference sequence” here refers to image sequences used to configure the classifier-localizer module. More generally, the expression “reference data” is also used hereinafter to refer to data used to configure the classifier-localizer module.

This invention allows to accurately identify one or more objects in an optical scene, even if the objects are distant. More specifically, this invention allows this accurate identification by reliably assigning a class to an object present in an image sequence and by localizing this object with accuracy.

Furthermore, the classifier-localizer module is configured to minimize a multi-objective loss function representative both of an objective of classification of one or more objects in an image sequence and of an objective of localization of these objects. This invention thus implements a joint optimization of the tasks of classification and localization, two intrinsically linked tasks. In an embodiment, it can thus be considered that the tasks of classification and localization are learnt in parallel by the classifier-localizer module based on reference sequences during its configuration. The visual information related to an object—for example, the size, the shape, the displacement etc. —are exploited by the classifier-localizer module to perform in parallel these two tasks of classification and localization. As a consequence of the joint and parallel optimization described here, this invention allows, synergistically, to improve both the reliability of the class assigned to an object and the accuracy of the estimated position of an object.

According to an embodiment of the invention, the classifier-localizer module is configured by a configuring method in accordance with the invention.

According to an embodiment of the invention, said at least one estimated position comprises an estimated position of the object for each of the images of said sequence.

This particular embodiment allows to improve the accuracy of localization of an object present in an optical scene, a position of the object being estimated for each of the images of a sequence. In particular, if the times of capture of the images of a sequence are different, this embodiment allows to obtain an accurate localization over time of an object of the sequence, and thus to track the displacement of this object over time.

According to an embodiment of the invention, said step of determining the classifying and localizing method comprises sub-steps of:
determining data encoded by an encoder based on the obtained image sequence;
determining said at least one class assigned by a classifier based on the encoded data; and
determining said at least one position estimated by a localizer based on the encoded data.

This embodiment of the invention has the following advantages. A multidimensional intermediate representation of the optical scene is obtained in this embodiment: said encoded data. Since the encoded data are provided as input to the classifier and to the localizer, both the performed tasks make use of one and the same intermediate representation. This use of an intermediate representation common to the tasks of classification and localization allows to reinforce the synergy effect related to the joint and parallel optimization of these two tasks. In combination with the abovementioned multi-objective optimization, the intermediate representation is representative of both visual characteristics of an object required for the classification and visual characteristics of this object required for the localization. Thus, the classifier, to reliably class an object, takes advantage of the visual characteristics related to the localization (for example, the size and speed of displacement of the object); and, correlatively, the localizer, to accurately estimate the position of an object, takes advantage of the visual characteristics related to the classification (for example, the shape and visual appearance of the object).

According to an embodiment of the invention, the encoder implements one or more convolutions between the obtained image sequence and a number of filters.

The term “convolution” here refers to a convolution product, the mathematical operation generally written *.

The fact of performing, in this embodiment, convolutions between the image sequence and of filters allows to extract spatial and/or temporal characteristics of the object in the image sequence. The encoder produces, according to this embodiment, encoded data representative of spatio-temporal characteristics of object. These encoded data constitute an intermediate representation provided as input to the classifier and the localizer. Consequently, this embodiment allows to highlight the spatio-temporal characteristics of an object in an image sequence and thus to improve the reliability of the classification and the accuracy of the localization performed jointly and in parallel.

According to an embodiment of the invention, said convolutions implemented by the encoder are convolutions in the spatial domain and in the time domain.

The fact of using convolutions both in the spatial domain and in the time domain allows to extract characteristics related to the object in these two domains. This embodiment allows to obtain, based on the image sequence, information items related to the object in space and in time (for example, the displacement of an object over time, the speed thereof, the variation in shape, etc.).

According to an embodiment of the invention, said step of obtaining an image sequence comprises a sub-step of capturing, by at least one camera, said one or more images.

The term “camera” here refers to a device allowing the conversion of optical images into electronic images.

According to an embodiment of the invention, the classifier-localizer module, used to perform said determining step of the method, comprises a neural network.

The term “neural network” here refers to a network of artificial neurons, thus comprising an assembly of artificial neurons connected to one another, an artificial neuron making it possible to determine an activation function of weighted and combined inputs.

The fact of using a neural network to implement the classifier-localizer module allows to obtain a reliable classification of an object in an image sequence and an accurate localization of this object. In particular, a neural network is able to process complex and non-linear cases and thus to obtain a significantly improved performance by comparison with analytical models. This last point is particularly advantageous for the classification and localization of distant objects, a scenario in which the effects of atmospheric attenuation are particularly significant.

In combination with the multi-objective optimization based on reference image sequences described above, this embodiment has the advantage of not requiring any a priori knowledge related to the physical environment and/or to the parameters of the camera. By way of illustration, no knowledge of the physical model of atmospheric attenuation is required to classify an object and estimate the position thereof, which is a major advantage with regard to existing solutions.

This embodiment also allows to make use of a significant quantity of implicit knowledge related to the reference image sequences. For example, the greater the variety of scenarios represented by the reference image sequences, the more benefit the neural network can derive from the knowledge related to these reference sequences.

Moreover, the fact of using a single neural network to implement, jointly and in parallel, the two tasks of classification and localization allows to simplify the practical implementation in a system, for example in an onboard system such as a drone or an autonomous car. Specifically, by making use of a single neural network for both these tasks, the hardware and software limitations of implementation (e.g. size of the memory, required computing capacity etc.) are relaxed, while allowing the implementation of a reliable classification of an accurate localization.

In the event of a forward-propagation neural network being exploited, the network is a universal approximator and is thus able to approximate any continuous function over compact subsets of the set of real numbers, on condition that the latter includes enough neurons. Making use of a neural network thus allows to implement varied image processing and analysis functions.

According to an embodiment of the invention, said one or more images of the obtained sequence are consecutive. Furthermore, the step of obtaining the image sequence comprises a sub-step of cropping said one or more captured images, one of said objects being centered on a determined image (i.e. a certain image) of the sequence.

The term “consecutive images” here refers to images which are consecutive over time, and thus to images, the capture times of which follow one another chronologically over time.

The cropping operation performed in this embodiment has the effect of providing, as input to the classifier-localizer module, an item of information about the displacement of an object within the image sequence. Since the images are successive over time, the relative displacement of an object within the sequence is representative of the speed of this object. Thus, the item of displacement information of an object is highlighted by this cropping operation then exploited by the classifier-localizer module to improve the reliability of the classification and the accuracy of the localization.

In addition, the cropping operation also allows to reduce the size of the images processed by the method, while keeping the useful part of the images comprising an object to be identified and localized. With a reduced image size, and with no loss of useful information, the implementation in a practical system of the classification and localization tasks is simplified on the hardware and software front, with no degradation of performance.

By comparison with existing methods of automatic classification of an object in one or more images, this invention furthermore allows to improve the reliability of classification of an object. Specifically, the existing methods are more suitable for classifying an object on a single image and cannot make use of information relating to the displacement of an object over time.

According to another aspect of the invention, a method for configuring a classifier-localizer module for classifying and localizing objects in image sequences is proposed, said method comprising a step of initializing the classifier-localizer module (particularly of its parameters); and at least one iteration of the steps of:
determining, by the classifier-localizer module based on at least one reference image sequence:
   at least one class assigned to at least one object in said at least one reference sequence, said at least one assigned class being selected from among a list of classes; and
   at least one estimated position of said at least one object;
evaluating a multi-objective loss function on the basis of said at least one assigned class, of said at least one estimated position, of at least one known class and of at least one known position of at least one object in said at least one reference sequence, the multi-objective loss function being representative both of an objective of classification and of an objective of localization of objects;
reconfiguring the classifier-localizer module to minimize the multi-objective loss function.

This invention allows to configure a classifier-localizer module making it possible to implement a reliable classification of one or more objects in an image sequence and an accurate localization of said objects.

The classifier-localizer module used is configured to minimize a multi-objective loss function representative both of an objective of classification of one or more objects in reference image sequences and an objective of localization of these objects. This invention thus proposes configuring a module which jointly optimizes the classification and localization. Since these two tasks are intrinsically related, the proposed joint and parallel optimization has a synergy effect, as described hereinafter. By comparison with separate modules configured independently to optimize the classification and localization, the classifier-localizer module configured by this invention allows to implement both a more reliable classification and a more accurate localization.

According to an embodiment of the invention, said step of evaluating the multi-objective loss function comprises sub-steps of:
evaluating a classification loss function based on said at least one assigned class and on at least one known class associated with said at least one object of said at least one reference image sequence;
evaluating a localization loss function based on said at least one estimated position and on at least one known position associated with said at least one object of said at least one reference image sequence; and
evaluating the multi-objective loss function based on the result of the classification loss function and on the result of the localization loss function.

The loss function is described as “multi-objective” because it is representative both of an objective of classification and of an objective of localization. This embodiment allows to evaluate, on the one hand, the reliability of the assigned classes and, on the other hand, the accuracy of the estimated positions, and to deduce therefrom a loss function common to both these tasks. Thus, this embodiment allows to independently evaluate the objective of classification and the objective of localization, while guaranteeing that the classifier-localizer module jointly optimizes these two objectives.

According to an embodiment of the invention, the multi-objective loss function is defined on the basis of a weighted sum of the classification loss function and of the localization loss function, the weighting coefficients being non-zero coefficients.

The fact of using a weighted sum allows to adjust the importance given by the multi-objective loss function to one of the two objectives of classification and localization with respect to one another. This embodiment allows to prioritize, or not prioritize, one objective over the other. However, since the multi-objective loss function is representative of both these objectives, the weighting coefficients are non-zero numbers. Furthermore, this embodiment allows to adapt the multi-objective loss function to cases where the classification loss function and the localization loss function produce output values with different orders of magnitude.

According to an embodiment, the classification loss function is evaluated using the expression:

$${L}_{E C} ( {C}_{r} , {p}_{o} ) = - {\sum }_{i = 1}^{M} δ ( {C}_{i} , {C}_{r} ) \cdot ln ( {p}_{o , i} ) ,$$

where L_{EC} is the classification loss function, M is the number of assignable classes of said list of classes, δ(Cᵢ, Cᵣ) is a binary indicator equal to 0 if for a said object the class Cᵢ of said list of classes is different from the known class Cᵣ of said object and otherwise equal to 1, and pₒ=(p_{o,i})_{1≤i≤M} with p_{o,i} a probability determined by the classifier-localizer module that said object belongs to the class Cᵢ.

According to an embodiment, the localization loss function is evaluated using the expression:

$${L}_{IMSE} ( I , {P}_{r} , {P}_{o} ) = \frac{1}{{‖ I ‖}_{1}} {\sum }_{i = 1}^{N} {I}_{i} \cdot {( {P}_{r , i} - {P}_{o , i} )}^{2} ,$$

where L_{IMSE} is the localization loss function, N is the number of images of said at least one reference sequence I=(Iᵢ)_{1≤i≤N} with ∥I∥₁=Σᵢ|Iᵢ| and Iᵢ a binary indicator equal to 1 if a said object is present in an image of index i of said at least one reference sequence and otherwise equal to 0, Pₒ=(P_{o,i})_{1≤i≤N} with P_{o,i} the estimated position of said object determined by the classifier-localizer module for the image of index i, and Pᵣ=(P_{r,i})_{1≤i≤N} with P_{r,i} the known position of said object for the image of index i.

According to an embodiment of the invention, said step of reconfiguring the classifier-localizer module is performed using a gradient descent algorithm based on the result of the multi-objective loss function obtained in said evaluating step.

In this embodiment, a gradient descent algorithm allows to reconfigure the classifier-localizer module, particularly its parameters, in order to minimize the multi-objective loss function. This embodiment allows to configure the classifier-localizer module on the basis of reference data and thus to implement a reliable classification of an object in an image sequence and an accurate localization thereof.

According to an embodiment, the classifier-localizer module comprises a neural network and a gradient descent algorithm is used for the reconfiguration—in this case, reference is made to a gradient backpropagation method. This embodiment allows to train the neural network on the basis of reference data in order to minimize the multi-objective loss function and thus obtain a classifier-localizer module implementing a reliable classification of an object in an image sequence and an accurate localization thereof.

By way of example, the reconfiguring step consists in updating the parameters of the network, such as the weight of each neuron of the network. The gradient backpropagation method has the aim of correcting the errors according to the size of the contribution of each element to these. The weights contributing the most to an error will be modified more significantly than the weights causing a marginal error.

According to an embodiment of the invention, said at least one reference image sequence comprises at least one of the elements of the following group:
one or more images captured by at least one camera; and
one or more synthesized images.

The term “synthesized” here refers to computer-generated images.

This embodiment allows to obtain reference data making it possible to configure the classifier-localizer module.

The embodiment, in which the reference images are captured by at least one camera, allows, inter alia, to capture reference images representative of observed real conditions. In this way, the classifier-localizer module obtained is effective under real conditions.

The embodiment according to which the reference images are synthesized allows to increase the volume of reference data used to configure the classifier-localizer module. Generating reference images by computer furthermore allows to form reference data representative of varied scenarios, for example different levels of atmospheric attenuation, different meteorological conditions. Consequently, this allows to configure a classifier-localizer module which minimizes a multi-objective loss function for a wide variety of scenarios.

When the last two embodiments are taken in combination, this allows to obtain a large number of reference image sequences representative both of observed real conditions and varied scenarios. Thus, a classifier-localizer module configured based on such reference data will implement a more reliable classifier-localizer module and a more accurate localization.

According to an embodiment of the invention, the method for configuring a classifier-localizer module comprises several iterations of said steps of determining, evaluating the multi-objective loss function, and reconfiguring the classifier-localizer module.

The fact of performing several iterations of said steps of determining, evaluating and reconfiguring allows to improve the classifier-localizer module over the successive iterations to minimize the multi-objective loss function. Typically, the greater the number of iterations, the more the classifier-localizer module used will minimize the multi-objective loss function. Consequently, this embodiment allows to improve the reliability of classification and accuracy of localization implemented by the classifier-localizer module.

Let us consider here the embodiment according to which several said iterations are performed and a gradient descent algorithm is used to reconfigure the classifier-localizer module. It is advantageous to perform several iterations over portions of reference data, rather than a single iteration over the set of reference data. Specifically, this allows to improve, over the iterations, the convergence on a classifier-localizer module that minimizes the multi-objective loss function. This embodiment also allows to require fewer hardware and software resources—in terms of memory size, processing resources, etc. —to configure the classifier-localizer module. Thus, the complexity of implementation of the determining method on the hardware and software front is simplified by this embodiment.

According to another aspect of the invention, a device for classifying and localizing at least one object in an image sequence is proposed, said device comprising:
an obtaining module for obtaining a sequence of one or more images captured by at least one camera; and
a classifier-localizer module for determining, based on the obtained image sequence:
   at least one class assigned to said at least one object, said at least one assigned class being selected from among a list of classes; and
   at least one estimated position of said at least one object.

Said classifier-localizer module is configured based on at least one reference image sequence to minimize a multi-objective loss function representative both of an objective of classification and an objective of localization of objects in said at least one reference image sequence.

The classifying and localizing device according to this embodiment possesses the advantages described above in relation to the classification and localization method for which provision is made.

According to an embodiment of the invention, said classifier-localizer module used by the device is configured by a configuring method in accordance with the invention.

This embodiment allows to benefit, within the classifying and localizing devices, from the advantages mentioned previously in relation to the configuring method for which provision is made.

According to another aspect of the invention, a system comprising a classifying and localizing device in accordance with the invention and at least one camera configured to capture said one or more images of the sequence is proposed.

The advantage of this embodiment is to be able, within a practical system, to jointly perform both the tasks of classification and localization with a single device.

This embodiment allows an effective practical implementation of a surveillance or navigation system, the classification of objects in an optical scene and the localization of these objects being critical tasks for these types of systems.

According to an embodiment, the proposed system comprises a single camera.

This embodiment allows to only require a single camera to perform both the classification and the localization of an object in an optical scene, which is advantageous by comparison with existing solutions. In addition, a camera is an item of equipment commonly integrated into onboard systems, a camera being inexpensive, and of small bulk. Thus, a reliable classification and an accurate localization of an object in an optical scene are, according to this embodiment, implemented economically and with a small bulk in a practical system, such as an onboard system.

According to an embodiment, the proposed system comprises a plurality of cameras.

This embodiment, by using a plurality of cameras, allows to extend the total field of view of the system for which provision is made. This embodiment thus allows to classify and localize objects in a wider geographic area. According to an embodiment, said system is a surveillance system, or a navigation system.

According to an embodiment, the system for which provision is made is on board (i.e. integrated into) a vehicle such as an aircraft, a ship, a railway vehicle, a road vehicle, etc.

According to another aspect of the invention, an aircraft comprising a system in accordance with the invention is proposed.

According to an aspect of the invention, a computer program comprising instructions for implementing the steps of a method in accordance with the invention, when the computer program is executed by at least one processor or one computer, is proposed.

The computer program can be formed of one or more sub-parts stored in one and the same memory or in separate memories. The program can use any programming language, and be in the form of source code, object code, or intermediate code between source code and object code, such as in a partially compiled form, or in any other desirable form.

According to an aspect of the invention, an information medium readable by a computer comprising a computer program in accordance with the invention is proposed.

The information medium can be any entity or device capable of storing the program. For example, the medium may include a storage means, such as a non-volatile memory or ROM, for example a CD-ROM or a microelectronic circuit ROM, or else a magnetic recording means, for example a diskette or a hard disk. Moreover, the storage medium may be a transmissible medium such as an electrical or optical signal, which can be conveyed by an electrical or optical cable, by radio or by a telecommunication network or by a computer network or by other means. The program according to the invention can in particular be downloaded over a computer network. Alternatively, the information medium can be an integrated circuit into which the program is incorporated, the circuit being suitable for executing or for being used in the execution of the method in question.

### BRIEF DESCRIPTION OF THE DRAWINGS

Other features and advantages of this invention will become apparent from the description provided hereinafter of embodiments of the invention. These embodiments are given by way of illustrative example and are in no way limiting. The description provided hereinafter is illustrated by the appended drawings:

FIG. 1 schematically represents an example of a device for classifying and localizing at least one object in an image sequence according to an embodiment of the invention;

FIG. 2 schematically represents an example of an image sequence obtained and processed by a device for classifying and localizing at least one object in an image sequence according to an embodiment of the invention;

FIG. 3 schematically represents an example of a functional architecture of a device for classifying and localizing at least one object in an image sequence according to an embodiment of the invention;

FIG. 4 represents, in the form of a block diagram, steps of a method for classifying and localizing at least one object in an image sequence according to an embodiment of the invention;

FIG. 5 represents, in the form of a block diagram, steps of a method for configuring a classifier-localizer module for implementing a classification and a localization of at least one object in an image sequence according to an embodiment of the invention;

FIG. 6 schematically represents an example of a functional architecture of a device for classifying and localizing at least one object in an image sequence according to an embodiment of the invention;

FIG. 7 schematically represents an example of a software and hardware architecture of a system for classifying and localizing at least one object in an image sequence according to an embodiment of the invention;

FIG. 8 schematically represents an example of a functional architecture of a device for classifying and localizing at least one object in an image sequence according to an embodiment of the invention.

### DESCRIPTION OF EXAMPLE EMBODIMENTS

This invention relates to a method and a device for classifying and localizing objects in an image sequence, and a method for configuring a classifier-localizer module for classifying and localizing objects in image sequences, along with an associated system, computer program and information medium.

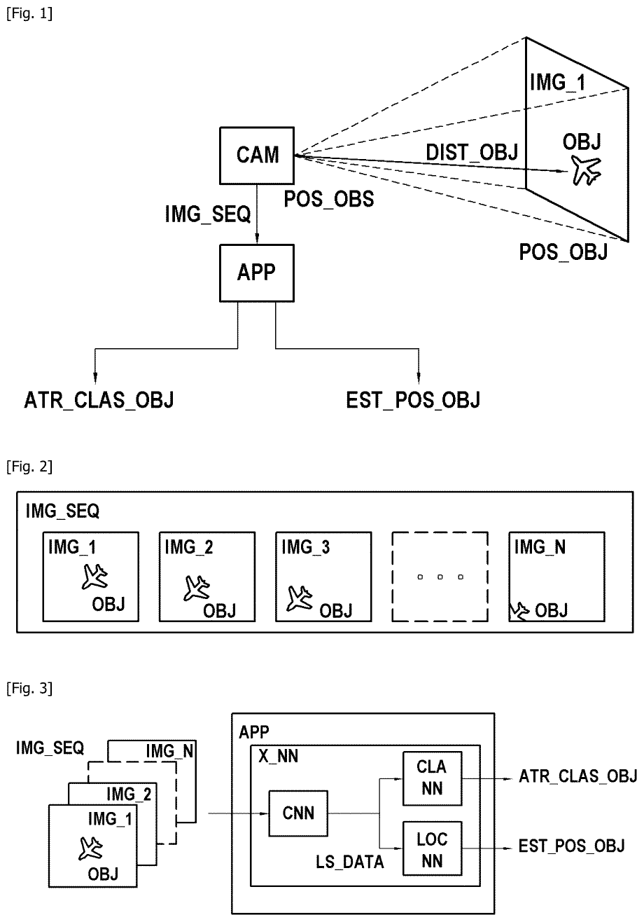

FIG. 1 schematically represents an example of a device for classifying and localizing at least one object in an image sequence according to an embodiment of the invention.

As illustrated by FIG. 1, the classifying and localizing device APP is configured to receive as input an image sequence IMG_SEQ and produce as output a class ATR_CLAS_OBJ assigned to an object OBJ as well as an estimated position EST_POS_OBJ of the object OBJ. The image sequence IMG_SEQ typically comprises a plurality of images IMG_1, . . . , IMG_N. The images IMG_1, . . . , IMG_N are captured by a camera CAM and are composed of a plurality of pixels. For example, the pixels of an image IMG_1 are encoded over one or more bits: one bit per pixel in the case of a monochrome image, 8 bits per pixel to have access to 256 colors, etc. The camera CAM is connected to the device APP so that the camera CAM can transmit the image sequence IMG_SEQ to the device APP. The images IMG_1, . . . , IMG_N of the sequence IMG_SEQ are representative of an optical scene comprising the material object OBJ. By way of example, the object OBJ can be a vehicle, an aircraft, a pedestrian, a house etc. It should be noted that the object OBJ can be in motion or not. The class ATR_CLAS_OBJ assigned to the object OBJ is selected from among a finite list of assignable classes, such as a list of aircraft models, vehicle types, categories of objects, etc.

The device APP produces, based on the sequence IMG_SEQ, an estimate EST_POS_OBJ of the position POS_OBJ of the object OBJ. The position POS_OBJ of the object OBJ is either an absolute position or a relative position. If the position POS_OBJ is absolute, then it denotes a position defined with respect to a terrestrial reference frame. It should be noted that, according to an embodiment, the device APP determines an absolute position of the object OBJ based on the sequence IMG_SEQ and on the position (e.g. geographical coordinates) of the device APP. According to a variant embodiment, the absolute position POS_OBJ can correspond to geographical coordinates of the material object OBJ such that the position POS_OBJ of the object OBJ comprises one or more coordinates of the following set: the latitude, the longitude, and the altitude.

According to an embodiment, the position POS_OBJ of the object is a relative position defined with respect to an observer position POS_OBS. The position POS_OBJ comprises, in an embodiment, one or more coordinates from the following set: an azimuth, a height, and a distance defined with respect to the observer position POS_OBS. According to a variant embodiment, and as illustrated by FIG. 1, the estimated position EST_POS_OBJ is an estimate of the distance DIST_OBJ between the observer position POS_OBS and the object OBJ. Typically, the distance DIST_OBJ denotes the distance between the material object OBJ and the camera CAM capturing the image sequence IMG_SEQ.

According to an embodiment, the position POS_OBJ of the object OBJ is a relative position defined with respect to a preceding position of the object OBJ. In this embodiment, the position EST_POS_OBJ estimated by the device APP thus corresponds to a displacement of the material object OBJ, and for example comprises one or more coordinates from among: a longitudinal displacement, a lateral displacement, and a vertical displacement. According to a variant embodiment, the device APP produces an estimate EST_POS_OBJ relative to the displacement of the object OBJ between two images IMG_1, IMG_2 of the sequence IMG_SEQ, and/or produces an estimate of the speed of the object OBJ.

The camera CAM is an image capturing device IMG_SEQ, making it possible to convert optical images into digital images. To do this, the camera CAM comprises a sensor of electromagnetic radiation of wavelengths belonging to the visible light spectrum. According to an embodiment of the invention, the camera CAM comprises a sensor of electromagnetic radiation of wavelengths lying outside the visible light spectrum, such as an infrared sensor. The camera CAM can, according to this embodiment, capture images IMG_SEQ in the infrared region.

Of course, no limitation is attached to the nature of the communication interface between the device APP and the camera CAM, which can be wired or wireless, and can implement any protocol known to those skilled in the art (Internet, IP, Ethernet, Wi-Fi, Bluetooth, 3G, 4G, 5G, 6G, etc.). Furthermore, no limitation is attached to the format of the images IMG_1, . . . , IMG_N of the sequence IMG_SEQ, which can implement any encoding known to those skilled in the art (JPG, PNG, TIFF, etc.).

FIG. 2 schematically represents an example of a sequence of images obtained by a device for classifying and localizing at least one object in an image sequence according to an embodiment of the invention.

As illustrated by FIG. 2, the image sequence IMG_SEQ comprises one or more images IMG_1, . . . , IMG_N. Typically, the image sequence IMG_SEQ comprises a plurality of images IMG_1, . . . , IMG_N.

According to an embodiment, the images IMG_1, . . . , IMG_N of the sequence IMG_SEQ are representative of an optical scene comprising an object OBJ in motion. According to an embodiment, the images IMG_1, . . . , IMG_N of the sequence IMG_SEQ are consecutive over time, i.e. the respective times of capture of the images IMG_1, . . . , IMG_N of the sequence IMG_SEQ follow one another over time. The first image IMG_1 thus corresponds to the oldest image, while the last image IMG_N corresponds to the most recent image. According to an embodiment, the classifying and localizing device APP performs an operation of cropping of the images IMG_1, . . . , IMG_N of the sequence IMG_SEQ so that the object OBJ is centered in the first image IMG_1. The cropping coordinates remain fixed for all the images IMG_1, . . . , IMG_N of the sequence IMG_SEQ. As shown in FIG. 2, the cropping operation allows to visually represent and highlight an item of information about the displacement of the object OBJ within the image sequence IMG_SEQ and over time.

According to an embodiment of the invention, the image sequence IMG_SEQ comprises a plurality of images IMG_1, . . . , IMG_N captured by a plurality of cameras CAM. According to an embodiment, the image sequence SEQ_IMG is representative of an optical scene comprising a plurality of material objects OBJ. Moreover, according to an embodiment, the image sequence SEQ_IMG is representative of a plurality of optical scenes.

According to the embodiment described above, the device APP uses images IMG_SEQ captured by a plurality of cameras CAM. It should then be mentioned that, according to this embodiment, the fields of view of the different cameras CAM are separate. In this way, an object OBJ of interest present in the field of view of a first camera will then be observed by a second camera when the object OBJ leaves the field of view of the first camera. Moreover, according to this embodiment, the different cameras CAM possess identical lenses. This embodiment thus allows to expand the field of view of the proposed device APP and, thus, to classify and localize objects OBJ in a wider geographic area.

Furthermore, in a variant of the invention, the device APP implements a classification and a localization of several objects OBJ based on a sequence IMG_SEQ, at least one class ATR_CLAS_OBJ assigned to the objects OBJ and at least one estimated position EST_POS_OBJ of the objects OBJ being provided as output by the device APP.

FIG. 3 schematically represents an example of a functional architecture of a device for classifying and localizing at least one object in an image sequence according to an embodiment of the invention.

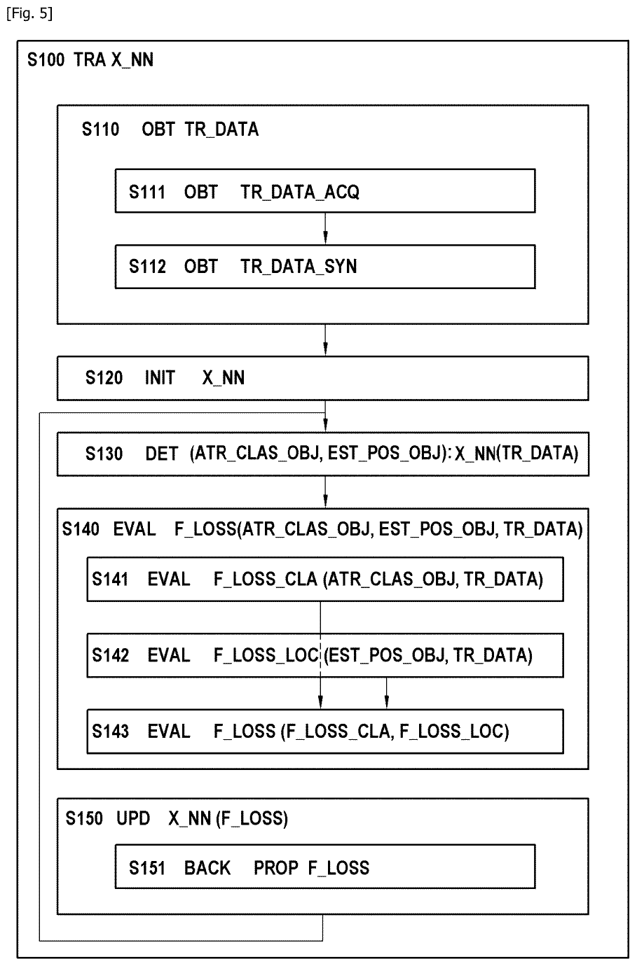

As illustrated by FIG. 3, the device APP receives as input a sequence IMG_SEQ of images IMG_1, . . . , IMG_N. The device APP determines, based on the sequence IMG_SEQ, a class ATR_CLAS_OBJ assigned to the object and an estimated position EST_POS_OBJ of the object OBJ. The outputs ATR_CLAS_OBJ, EST_POS_OBJ of the device APP are determined by a classifier-localizer module X_NN on the basis of the sequence IMG_SEQ. The manner of configuring the classifier-localizer module X_NN (i.e. its parameters) to obtain a reliable classification and an accurate localization is described in more detail hereinafter and illustrated by FIG. 5.

According to an embodiment, the determining step performed by the classifier-localizer module X_NN comprises the following operations. The image sequence IMG_SEQ is provided as input to an encoder CNN making it possible to produce as output encoded data LS_DATA. The encoded data LS_DATA are on the one hand provided as input to a classifier CLA_NN and on the other hand to a localizer LOC_NN. The classifier CLA_NN produces as output a class ATR_CLA_OBJ assigned to the object OBJ, while the localizer LOC_NN produces as output an estimated position EST_POS_OBJ. The encoded data LS_DATA thus constitute a multidimensional intermediate representation of the sequence IMG_SEQ common to the classification and localization tasks.

According to an embodiment, the classifier-localizer module X_NN comprises a parameterized function. More specifically, the classifier-localizer module X_NN comprises, in a variant, an automated machine learning algorithm, such as a support vector machine, a Bayesian network, etc.

According to a variant embodiment of the invention, the classifier-localizer module X_NN comprises (i.e. is implemented by) a neural network. In general, a neural network comprises one or more layers of artificial neurons connected to one another. An artificial neuron performs the following operations. A neuron takes as input one or more values and weights these inputs by coefficients known as weights. The neuron combines the weighted inputs as well as a skew, typically this combination operation is a sum, or a norm. This combination is then provided as input to an activation function. Examples of commonly used activation functions are sigmoid, ReLU (Rectified Linear Unit), or hyperbolic tangent functions. Finally, the output of the artificial neuron is the result of the activation function. In the context of a neural network, the parameters of a neural network comprise a varied set of parameters, such as weights, skews, and activation functions used for the different neurons of the network X_NN. These parameters thus allow to optimize the neural network X_NN to implement a reliable classification and an accurate localization. The types of neural network capable of implementing a classifier-localizer module X_NN in accordance with the invention are varied. They in particular include, without limitation, multilayer perceptrons, convolution or convolutional neural networks, recurrent neural networks, etc.

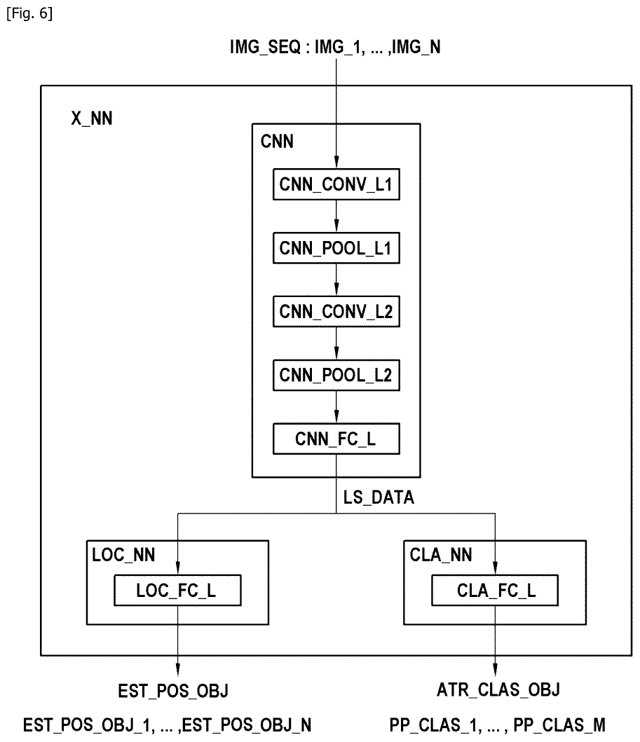

As illustrated by FIG. 3, and according to an embodiment of the invention, the neural network X_NN comprises: a convolutional neural network CNN; a classification neural network CLA_NN; and a localization neural network LOC_NN. In this particular embodiment, the encoder comprises the convolutional neural network CNN as described above making it possible to determine encoded data LS_DATA based on the sequence IMG_SEQ. The classifier comprises the classification neural network CLA_NN and, based on the encoded data LS_DATA, produces an assigned class ATR_CLAS_OBJ. The localizer comprises the localization neural network LOC_NN and allows to estimate the position EST_POS_OBJ based on the encoded data LS_DATA. A more detailed example of implementation of the classifier-localizer module X_NN by a neural network is provided hereinafter and illustrated by FIG. 6.

It is important to note here that, in this embodiment, the neural network X_NN is determined globally to minimize the multi-objective loss function F_LOSS representative both of an objective of classification and of an objective of localization. The neural networks CNN, CLA_NN and LOC_NN are thus determined jointly to minimize the loss function F_LOSS, and not independently. In an embodiment, it may be considered that the tasks of classification and localization implemented by the module X_NN are learnt in parallel.

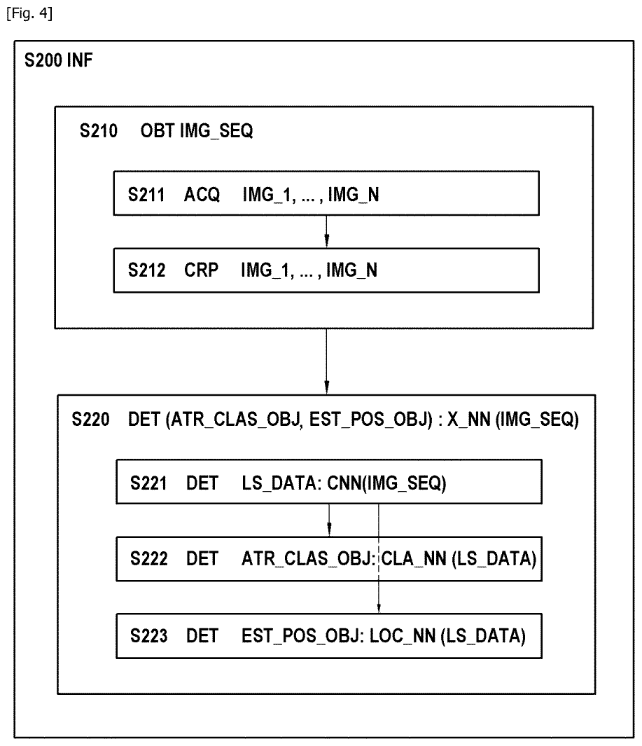

FIG. 4 represents, in the form of a block diagram, the steps of a method for classifying and localizing at least one object in an image sequence according to an embodiment of the invention.

As illustrated by FIG. 4, and according to an embodiment of the invention, the classifying and localizing method comprises the following steps and is implemented by a device APP. In this description, the reference signs of the steps related to the classifying and localizing method begin with S2.

In the step S210, a sequence IMG_SEQ of one or more images IMG_1, . . . , IMG_N captured by at least one camera CAM is obtained by the device APP.

In the step S220, the device APP provides the image sequence IMG_SEQ obtained as input to a classifier-localizer module X_NN which thus determines:
at least one class ATR_CLAS_OBJ assigned to said at least one object OBJ, said at least one assigned class ATR_CLAS_OBJ being selected from among a list of assignable classes; and
at least one estimated position EST_POS_OBJ of said at least one object OBJ.

The classifier-localizer module X_NN is configured based on reference image sequences to minimize a multi-objective loss function representative of both an objective of classification and an objective of localization of objects in the reference sequences.

As illustrated by FIG. 4, and according to a particular embodiment, the obtaining step S210 of the method described above comprises at least one of the following sub-steps.

In the sub-step S211, the device APP performs a capture by at least one camera of said one or more images IMG_1, . . . , IMG_N of the sequence IMG_SEQ. For example, the device APP commands a camera CAM to capture the images IMG_1, . . . , IMG_N of the sequence IMG_SEQ. In particular, the images IMG_1, . . . , IMG_N of the sequence IMG_SEQ can be captured by a camera CAM with a fixed time increment between the different capture times.

In the sub-step S212, the images IMG_1, . . . , IMG_N are cropped by the device APP to center an object OBJ in a determined image IMG_1 of the sequence IMG_SEQ. According to an embodiment, and as illustrated by FIG. 2, the object OBJ is centered on the first image IMG_1 of the sequence IMG_SEQ. In this embodiment, the images IMG_1, . . . , IMG_N of the sequence IMG_SEQ are consecutive over time. The respective capture times of the images IMG_1, . . . , IMG_N follow one another over time. Furthermore, the cropping coordinates remain fixed for all the images IMG_1, . . . , IMG_N of the sequence IMG_SEQ, which allows to represent the displacement of the object OBJ during the sequence. The cropping operation allows to reduce the size of the images processed and thus to reduce the complexity of implementation of the method, while keeping the information related to the displacement of the object OBJ within the image sequence IMG_SEQ.

As illustrated by FIG. 4, and according to a particular embodiment, the determining step S220 of the method described above comprises the following sub-steps.

In the step S221, the device APP determines encoded data LS_DATA. The encoded data LS_DATA are produced by the encoder CNN taking as input the image sequence IMG_SEQ.

In the step S222, the device APP provides as input to a classifier CLA_NN the encoded data LS_DATA which produces as output said at least one class ATR_CLAS_OBJ.

In the step S223, said at least one estimated position EST_POS_OBJ is produced by a localizer LOC_NN of the device APP taking as input the encoded data LS_DATA.

It should be noted that the order of the steps S222 and S223 described here is in no way limiting. The steps S222 and S223 can be performed simultaneously (i.e. in parallel), one before the other or conversely. The encoded data LS_DATA allow to obtain a multidimensional intermediate representation common to both the tasks of classification and localization and representative of spatio-temporal characteristics of the object OBJ in the image sequence IMG_SEQ.

FIG. 5 shows, in the form of a block diagram, steps of a method for configuring a classifier-localizer module to implement a classification and a localization of at least one object in an image sequence according to an embodiment of the invention.

As illustrated by FIG. 5, and according to an embodiment of the invention, the proposed configuring method comprises the following steps. In this description, the reference signs of the steps related to the configuring method begin with S1.

In the step S120, the classifier-localizer module X_NN making it possible to implement the classification and localization of objects OBJ in image sequences IMG_SEQ is initialized (e.g. its parameters). In the embodiment in which the classifier-localizer module X_NN comprises a neural network, the weights of the neural networks are, for example, initialized at random.

In the step S130, a reference image sequence TR_DATA is provided as input to the classifier-localizer module X_NN to determine: a class ATR_CLAS_OBJ assigned to the object OBJ from among a list of assignable classes; and at least one estimated position EST_POS_OBJ of the object OBJ. According to a variant embodiment, the step S130 comprises sub-steps similar to the steps S221, S222 and S223 described above. According to a particular embodiment, the classifier-localizer module X_NN produces, for a reference image sequence TR_DATA as input, a set of values PP_CLAS_1, . . . , PP_CLAS_M and a set of estimated positions EST_POS_OBJ_1, . . . , EST_POS_OBJ_N. For each image IMG_1, the classifier-localizer module X_NN provides an estimated position EST_POS_OBJ_1 of the object OBJ on the image IMG_1; and for each class of the list of assignable classes, the classifier-localizer module X_NN provides as output a value PP_CLAS_1 representative of a probability of the object OBJ belonging to this class.

According to an embodiment of the invention, several reference image sequences TR_DATA are used during the steps S130 and S140. Furthermore, a reference image sequence TR_DATA may comprise several material objects OBJ.

In the step S140, a loss function F_LOSS is evaluated based on the following inputs: said at least one assigned class ATR_CLAS_OBJ; said at least one estimated position EST_POS_OBJ; at least one known class of an object in the reference sequence TR_DATA; and at least one known position of an object in the reference sequence TR_DATA. The multi-objective loss function F_LOSS is representative both of an objective of classification and of an objective of localization. In this embodiment, it should be noted that reference data TR_DATA are used to configure the classifier-localizer module such that the loss function F_LOSS is minimized.

In the step S150, the classifier-localizer module X_NN is reconfigured (e.g. its parameters) to minimize the loss function F_LOSS. The result of the evaluation performed in the step S140 is, according to a variant of the invention, used to reconfigure the classifier-localizer module X_NN. According to an embodiment, this step consists in determining the value of parameters of the classifier-localizer module X_NN to minimize the loss function F_LOSS.

According to an embodiment, the determining method comprises several iterations of the steps S130, S140, and S150, which allows to minimize the loss function F_LOSS gradually over the iterations, and thus improve the performance of the classifier-localizer module X_NN. Typically, the greater the number of iterations, the more the loss function F_LOSS will be minimized. For example, the number of iterations performed by the method can be determined as follows. If during an iteration, the evaluation of the loss function in the step S140 produces a result below a certain threshold, then no additional iteration will be performed. In a different way, the method for configuring the classifier-localizer module X_NN can also perform said iterations until the variation of the loss function between two iterations is below a threshold, i.e. the difference between two consecutive results of the loss function is below the threshold.

As illustrated by FIG. 5, and according to a particular embodiment, the proposed configuring method, described above, comprises the following step.

In the step S110, reference data TR_DATA are obtained. More specifically, the reference data TR_DATA comprise: one or more reference image sequences; one or more known classes associated with objects OBJ of the reference sequences; one or more known positions associated with objects OBJ of the reference sequences.

According to a particular embodiment, the step S110 of obtaining reference data comprises at least one of the following sub-steps, as shown in FIG. 5.

In the sub-step S111, one or more reference image sequences TR_DATA_ACQ are captured by at least one camera CAM. The step S111 further comprises, according to a variant, the determination of one or more known classes and positions associated with one or more objects OBJ of the captured reference sequences TR_DATA_ACQ.

In the sub-step S112, and according to a variant of the invention, one or more image sequences TR_DATA_SYN synthesized by computer are obtained. For example, the synthesized reference sequences TR_DATA_SYN can be the result of simulations. In this embodiment, the simulation tool can produce, in addition to the synthesized reference image sequences TR_DAT_SYN, the known classes and the known positions associated with the objects of these reference sequences.

As illustrated by FIG. 5, and according to a particular embodiment, the step S140 of evaluating the multi-objective loss function F_LOSS of the method described above comprises the following sub-steps.

In the step S141, a classification loss function F_LOSS_CLA is evaluated, taking as inputs said at least one assigned class ATR_CLAS_OBJ and at least one known class TR_DATA associated with said at least one object of the reference image sequence TR_DATA. This step inter alia allows to evaluate the reliability of the classifications performed by the classifier-localizer module X_NN.

In the step S142, a localization loss function F_LOSS_LOC is evaluated, taking as inputs said at least one estimated position EST_POS_OBJ and at least one known position TR_DATA associated with said at least one object of the reference image sequence TR_DATA. The step S142 thus allows to accurately evaluate the localizations performed by the classifier-localizer module X_NN.

The order of the sub-steps S141 and S142 described here is no way limiting, these two steps being able to be performed simultaneously, one after another or conversely.

In the sub-step S143, the multi-objective loss function F_LOSS is evaluated based on the result of the classification loss function F_LOSS_CLA obtained in the sub-step S141 and on the result of the localization loss function F_LOSS_LOC obtained in the sub-step S142.

In a variant of the invention, the classification loss function F_LOSS_CLA is a cross-entropy function. Let us write Cy the known class TR_DATA associated with the object OBJ and pₒ the set of values PP_CLAS_I, . . . , PP_CLAS_M produced by the classifier-localizer module X_NN and representative of probabilities of the object OBJ belonging to each of the classes of the list. The classification loss function F_LOSS_CLA, here written L_{EC}, is then defined by:

$${L}_{E C} ( {C}_{r} , {p}_{o} ) = - {\sum }_{i = 1}^{M} δ ( {C}_{i} , {C}_{r} ) \cdot ln ( {p}_{o , i} ) , \qquad [ Math 1 ]$$

where δ(Cᵢ, Cᵣ) is a binary indicator equal to 0 if the class Cᵢ is different from the class Cᵣ and otherwise equal to 1, and p_{o,i} is the value PP_CLAS_I representative of a probability of the object OBJ belonging to the class of index i in the list.

According to an embodiment, the result of the localization loss function F_LOSS_LOC is determined based on the error between the estimated positions EST_POS_OBJ_1, . . . , EST_POS_OBJ_N of the object OBJ and the known positions of the reference sequence TR_DATA. In particular, the localization error is taken into account solely for images in which the object OBJ is present. A part of the images of the sequence may not comprise the object, the latter having left the frame. In this embodiment, the localization loss function F_LOSS_LOC is defined as follows. Let us write Pᵣ the set of known positions of the object OBJ for the reference sequence TR_DATA, and Pₒ is the set of the estimated positions EST_POS_1, . . . , EST_POS_OBJ_N of the object OBJ estimated by the classifier-localizer module X_NN for each of the images IMG_1, . . . , IMG_N of the reference sequence TR_DATA. To indicate the presence of the object OBJ in the reference sequence, the presence vector I=(I₁, . . . , I_{N}) is used. If the image of index i comprises the object OBJ, then the value of the component Iᵢ is equal to 1; and if this image does not comprise the object OBJ (e.g. the latter being outside the frame), then the component Iᵢ is equal to 0. The localization loss function F_LOSS_LOC, here written L_{IMSE}, is then defined by:

$${L}_{IMSE} ( I , {P}_{r} , {P}_{o} ) = \frac{1}{{‖ I ‖}_{1}} {\sum }_{i = 1}^{N} {I}_{i} \cdot {( {P}_{r , i} - {P}_{o , i} )}^{2} , \qquad [ Math 2 ]$$

where ∥I∥₁ is the norm L1 of the vector I, i.e. ∥I∥₁=Σᵢ|Iᵢ|, Iᵢ is a binary indicator equal to 1 if the object is present in the image of index i in the sequence is equal to 0 otherwise, P_{o,i} is the position estimated by the classifier-localizer module X_NN for the image of index i in the list, and P_{r,i} is the known position for the image of index i in the sequence. It can be seen that in this embodiment the localization loss function F_LOSS_LOC is expressed based on quadratic errors. Thus, the proposed localization loss function F_LOSS_LOC is an extension of a loss function of mean squared error type.

The expression of the localization loss function F_LOSS_LOC described above is defined for positions of the object OBJ of a dimension, for example a distance between the object OBJ and the camera CAM capturing the images IMG_1, . . . , IMG_N. However, this expression constitutes only a variant embodiment. Such an expression of the localization loss function F_LOSS_LOC can easily be extended for positions comprising several coordinates, particularly by using the quadratic error between the estimated position and the known position on each component associated with the dimensions.

According to an embodiment, the estimated position of an object comprises a distance between an observer position and the object. According to this embodiment, the classifier-localizer module is configured to minimize the multi-objective loss function representative of the objective of classification and of the objective of localization of objects in the reference sequence, the objective of localization of an object comprising an objective of determination of a distance between an observer position and said object.

The multi-objective loss function F_LOSS to be minimized is, according to a variant embodiment, a weighted sum of the classification loss function F_LOSS_CLA and of the localization loss function F_LOSS_LOC. The weighting coefficients of this sum are non-zero, a necessary condition for the multi-objective loss function F_LOSS to be representative both of an objective of classification and an objective of localization. In particular, the loss function F_LOSS, here written L, is expressed by:

$$L ( {C}_{r} , {p}_{o} , {P}_{p} , {P}_{r} ) = α \cdot {L}_{E C} ( {C}_{r} , {p}_{o} ) + β \cdot {L}_{IMSE} ( I , {P}_{p} , {P}_{r} ) , \qquad [ Math 3 ]$$

where α and β are positive non-zero weighting coefficients, e.g.

$$α , β ∈ {ℝ}_{*}^{+} .$$

By way of example, the value of α is equal to 1 and the value of β to 10⁻³.

As illustrated by FIG. 5, and according to a particular embodiment, the updating step S150 of the method described above comprises the following sub-step.

In the sub-step S151, the classifier-localizer module X_NN is reconfigured, using a gradient descent algorithm on the basis of the result obtained in the step S140 of the loss function F_LOSS. In the embodiment in which the classifier-localizer module comprises a neural network, gradient backpropagation is used to update the parameters of the network, and in particular to determine the weights of it.

According to an embodiment, a gradient descent algorithm is used to configure the classifier-localizer module X_NN. In this embodiment, the reconfiguring step consists in updating the parameters of the classifier-localizer module X_NN. To do this, the gradient of the loss function F_LOSS is evaluated. Next, the parameters of the module X_NN are updated using the evaluated gradient. In particular, in the case of a gradient descent algorithm, the parameters are updated by subtracting therefrom the value of the evaluated gradient multiplied by a positive real coefficient. Thus, a gradient descent algorithm aims to minimize the loss function.

According to an embodiment, the classifier-localizer module X_NN comprises a neural network and a gradient backpropagation method is used to update the neural network. In this embodiment, the step S151 of reconfiguring the network X_NN consists in determining the values of the weights used by the artificial neurons of the network X_NN. The gradient backpropagation method uses the result of the loss function F_LOSS to update the weights of the network X_NN. In particular, the gradient backpropagation method consists: in propagating the result of the loss function through the different layers of the neural network, from the output layer to the input layer; and in updating the weights of each layer based on said propagated results.

In the embodiment described previously in which the classifier-localizer module X_NN comprises an encoder CNN, a classifier CLA_NN and a localizer LOC_NN, it is important to note that the elements CNN, CLA_NN and LOC_NN of the module X_NN are determined jointly. Specifically, the reconfiguration of the classifier-localizer module X_NN is done based on the result of the multi-objective loss function F_LOSS, and not based on the results of the classification loss function F_LOSS_CLA and of the localization loss function F_LOSS_LOC. In other words, the classifier CLA_NN and the localizer LOC_NN are configured in parallel (i.e. jointly) for the purpose of optimizing a common objective of reliable classification and accurate localization, and not each independently to optimize their respective objective.

FIG. 6 schematically represents an example of a functional architecture of a device for classifying and localizing at least one object in an image sequence according to an embodiment of the invention.

As illustrated by FIG. 6 and previously mentioned, the classifying and localizing device APP comprises a classifier-localizer module X_NN for determining, based on an image sequence IMG_SEQ, at least one class ATR_CLAS_OBJ assigned to said at least one object OBJ of the sequence IMG_SEQ and at least one estimated position EST_POS_OBJ of said at least one object OBJ.

In the particular embodiment illustrated by FIG. 6, the classifier-localizer module X_NN produces as output an estimated position EST_POS_OBJ_1, . . . , EST_POS_OBJ_N of the object OBJ for each of the images IMG_1, . . . , IMG_N of the sequence IMG_SEQ. For example, the estimated position EST_POS_OBJ of the object OBJ estimated by the classifier-localizer module X_NN is the average of these estimated positions EST_POS_OBJ_1, . . . , EST_POS_OBJ_N, or the closest position, or else the furthest position. Furthermore, the classifier-localizer module X_NN produces, in addition to the class ATR_CLAS_OBJ assigned to the object OBJ, a set of values PP_CLAS_1, . . . , PP_CLAS_M. Each of the values PP_CLAS_1, . . . , PP_CLAS_M is representative of a probability of the object OBJ belonging to a class of the list of assignable classes. In other terms, for each class of the list, the classifier-localizer module X_NN provides a value PP_CLAS_1 characterizing the probability of the object OBJ belonging to this class. By way of illustration and without limitation, the classifier-localizer module X_NN assigns to the object OBJ of the sequence IMG_SEQ the class for which the value PP_CLAS_1 is the highest.

According to an embodiment of the invention, described above and illustrated by FIG. 3, the classifier-localizer module X_NN comprises: an encoder CNN providing as output encoded data LS_DATA based on the sequence IMG_SEQ; a classifier CLA_NN, the output of which is at least one class ATR_CLA_OBJ assigned to the object OBJ and is determined based on the encoded data LS_DATA; and a localizer LOC_NN for determining an estimated position EST_POS_OBJ of the object on the basis of the encoded data LS_DATA. FIG. 6 illustrates a particular embodiment of the invention in which the encoder CNN, the classifier CLA_NN and the localizer LOC_NN are respectively implemented by a neural network.

In the embodiment described here, the encoder CNN is implemented using a convolutional neural network. In particular, the convolutional neural network is structured as follows. The convolutional neural network CNN, as shown in FIG. 6, comprises: one or more convolution layers CNN_CONV_L1, CNN_CONV_L2; one or more subsampling layers CNN_POOL_L1, CNN_POOL_L2, so-called “pooling” layers; and at least one fully connected layer CNN_FC_L, the nodes of this layer being all connected to the nodes of the following layer. Of course, the network CNN comprises, according to other variants of the invention, other layers of neurons, no limitation being attached to the nature of these latters.

The function of a convolution layer is to perform convolution operations between the input data of the layer and filters, filters commonly known as kernels. In this description, and for the sake of simplicity, the term “convolution” is used to refer to a convolution product, the mathematical operation generally written *. In the case of discrete data in two dimensions, the convolution of an image I and of a filter F is defined by (I*F) [x, y]=Σᵢ ΣⱼI(i, j)×F(x−i, y−j). Taking the example of an image I provided as input and a convolution layer using two filters F₁ and F₂, the convolutions I*F₁ and I*F₂ are evaluated to obtain two intermediate images. These intermediate images produced at the output of a convolution layer are commonly known as feature maps. Thus, the parameters of a convolution layer are, inter alia, as follows: the number and size of the filters, the control increment and the margin used by the convolution layer (these last two parameters are more commonly referred to as “stride” and “padding” parameters.) In the context of an operation of convolution or pooling, the control increment and the margin respectively refer to the number of pixels by which the filter is moved at each shift and to a technique consisting in adding pixels to the border of the image provided as input (e.g. zero-padding). Thus, by performing convolutions, a convolution layer allows to extract spatio-temporal characteristics of images provided as input. In this case, in the aim of classifying and localizing an object OBJ in an image sequence IMG_SEQ, the convolution layers allow to highlight in the image sequence IMG_SEQ information about the object OBJ such as size, shape, speed, displacement information etc.

According to a particular embodiment of the invention, the convolution layers CNN_CONV_L1, CNN_CONV_L2 of the encoding neural network CNN perform convolutions between the sequence IMG_SEQ and filters in the spatial domain and in the time domain. Performing convolutions in the three dimensions of the image sequence IMG_SEQ, two dimensions for the spatial domain of the images and one dimension for the time domain of the sequence, allows to extract spatio-temporal characteristics of the image sequence IMG_SEQ. More specifically, according to a variant of the invention, the convolution layers perform so-called “pseudo-3D convolutions”. Details of the implementation of pseudo-3D convolutions are for example explained in the following document: Zhaofan Qiu, et al., “Learning spatio-temporal representation with pseudo-3d residual networks”, in proceedings of the IEEE International Conference on Computer Vision, pages 5533-5541, 2017. Making use of pseudo-3D convolutions allows to extract spatio-temporal characteristics of the image sequence IMG_SEQ, while reducing the complexity of the network, by comparison with conventional convolutions in three dimensions.

A pooling layer, also known as a sharing layer, allows to perform a subsampling of the data provided as input to the layer. Taking for example the case of an image, the image provided as input is partitioned into a plurality of rectangles of pixels, these rectangles being generally known as tiles, and one output value is produced per tile. With tiles of 2×2 pixels in size, the pooling layer allows a compression by a factor of 4 of the input data. By way of illustration, the output value for a tile is the maximum value of the data of the tile, such a pooling layer is commonly known as “Max-Pool 2×2”. In a different example, the output value associated with a tile is the minimum value of the input data of the tile; in this case, the expression “Min-Pool 2×2” is employed. Thus, a pooling layer allows to reduce the size of the data processed by the following layer of the neural network and thus reduce the complexity of this latter.

According to an embodiment, the convolutional network CNN comprises one or more successions of a convolution layer and a pooling layer. According to the particular embodiment illustrated by FIG. 6, the network CNN comprises two so-called successions and one fully-connected layer, i.e. CNN: CNN_CONV_L1>CNN_POOL_L1>CNN_CONV_L2>CNN_POOL_L2>CNN_FC_L. According to this variant, the images IMG_1, . . . , IMG_N of the sequence IMG_SEQ are provided as input to the first convolution layer CNN_CONV_L1, and the encoded data LS_DATA are produced as output of the fully-connected layer CNN_FC_L. According to a variant embodiment, the network CNN also comprises neural layers, so-called correction layers, inserted between the convolution and pooling layers mentioned above. These correction layers apply an activation function to all the pixels of the intermediate images, which allows to introduce non-linear complexities and thus to improve the processing performed by the network CNN. By comparison with a neural network of fully-connected multilayer perceptron type, a convolutional neural network allows an effective implementation of extraction of input data characteristics. Specifically, the successions of convolution and pooling layers have minimal complexity and connectivity, and thus a simplified practical implementation with better performance. Furthermore, fully-connected multilayer perceptrons used to implement such extractions of characteristics are prone to overtraining problems.

According to an embodiment, the convolutional neural network CNN is implemented using a neural network of ResNet type or one of its variants. The implementation of such a network is for example detailed in the document mentioned above by Zhaofan Qiu, et al.

According to an embodiment of the invention, the localization neural network LOC_NN comprises one or more neural layers. By way of example, the network LOC_NN is a multilayer perceptron. As illustrated by FIG. 6, and according to a variant of the invention, the localization neural network LOC_NN is a perceptron comprising a fully-connected layer LOC_FC_L, the inputs of which are the encoded data LS_DATA and the outputs of which are a set of estimated positions EST_POS_OBJ_1, . . . , EST_POS_OBJ_N. Each of the estimated positions EST_POS_OBJ_1 corresponds to an estimate of the position POS_OBJ of the object OBJ for an image IMG_1 of the sequence IMG_SEQ. According to an embodiment, an aggregate estimated position EST_POS_OBJ of the object OBJ is evaluated on the basis of the estimated positions EST_POS_OBJ_1, . . . , EST_POS_OBJ_N, for example taking the average, the median, the minimum or the maximum of these latters. By way of example, let us consider an embodiment in which the localization neural network LOC_NN produces a position estimate for each of the images of the sequence IMG_SEQ, and in which an estimated position EST_POS_OBJ_1 is an estimate of a distance DIST_OBJ between an object OBJ and a camera CAM. In this embodiment, and for a sequence IMG_SEQ of N images, the localization neural network LOC_NN comprises an output layer with N neurons, each of them producing an estimation value EST_POS_OBJ_1 of the distance DIST_OBJ associated with an image IMG_1.

According to an embodiment of the invention, the classification neural network CLA_NN is a neural network of “classifier” type. The network CLA_NN comprises one or more layers of neurons. By way of example, the network CLA_NN is a multilayer perceptron. As illustrated by FIG. 6, and according to a variant of the invention, the classification neural network CLA_NN is a perceptron comprising a fully-connected layer CLA_FC_L, the inputs of which are the encoded data LS_DATA and the outputs of which are a set of values PP_CLAS_1, . . . , PP_CLAS_M. These values are representative of a probability of the object OBJ belonging to the classes of the list of assignable classes. According to an embodiment, the class ATR_CLAS_OBJ assigned to the object is the class of the list for which the value PP_CLAS_1 is the highest. According to a variant embodiment, the network CLA_NN comprises a layer of “Softmax” type for determining, based on the outputs of the layer CLA_FC_L, the set of values PP_CLAS_1, . . . , PP_CLAS_M; the use of a Softmax layer allows to normalize the output values, such that these are between 0 and 1 and thus representative of probabilities. More specifically, for inputs x=(x₁, . . . , x_{K}), the outputs of the Softmax layer y=(y₁, . . . , y_{K}) are expressed by:

$${y}_{i} = \frac{exp ( {x}_{i} )}{{\sum }_{j} exp ( {x}_{j} )} . \qquad [ Math 4 ]$$

By way of example, let us consider an embodiment in which the classification neural network CLA_NN produces the set of values PP_CLAS_1, . . . , PP_CLAS_M. In this embodiment, and for a list of M assignable classes, the network CLA_NN comprises an output layer with M neurons, each of them producing a value PP_CLAS_1 representative of the probability of the object OBJ belonging to a class. In combination with the example described above of a network LOC_NN with N neurons as outputs, the neural network X_NN then comprises an output layer with M+N neurons.

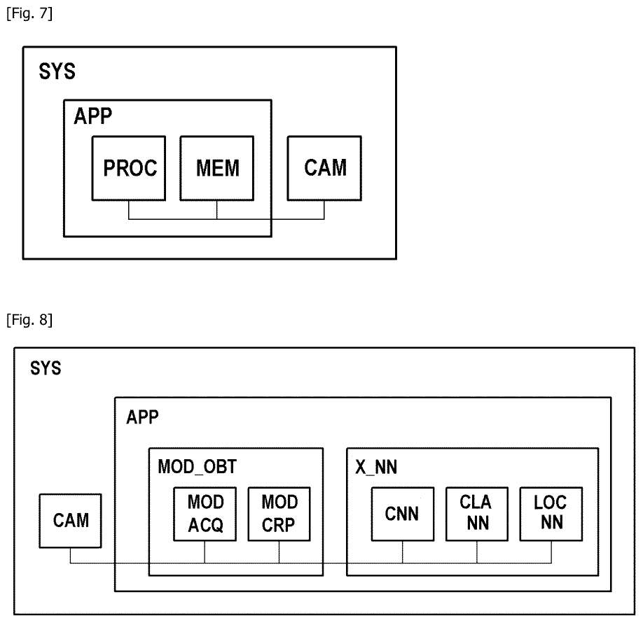

FIG. 7 schematically represents an example of a software and hardware architecture of a system for classifying and localizing at least one object in an image sequence according to an embodiment of the invention.

As illustrated by FIG. 7, the system SYS comprises a device APP and a camera CAM. The classifying and localizing device APP in particular comprises: a processing unit or processor PROC; and a memory MEM. Of course, the device APP comprises interfaces and a communication module for exchanging data with the camera CAM. The device APP has the hardware architecture of a computer, and includes, in this regard, a processor PROC, a random-access memory, a read-only memory MEM, and a non-volatile memory.

In the embodiment described here, the memory MEM associated with the device constitutes an information or recording medium in accordance with the invention, readable by computer and by the processor PROC and on which is recorded a computer program in accordance with the invention. The computer program includes instructions for implementing the steps of a method according to the invention, when the computer program is executed by the processor PROC. The computer program defines the functional modules represented by FIG. 8 of the device APP which are based on or control the hardware elements of this latter.

By way of illustration, the system SYS is on board a vehicle, for example in a terrestrial vehicle: car, truck, train etc., or in a marine vehicle: boat, frigate, or else in an aerial vehicle: an aircraft, a helicopter, an airplane, a drone, etc. In particular, the system SYS is according to a variant embodiment on board a so-called autonomous vehicle, such as an autonomous car or a drone. According to an embodiment of the invention, the system SYS constitutes a surveillance system or a navigation system.

FIG. 8 schematically represents an example of a functional architecture of a device for classifying and localizing at least one object in an image sequence according to an embodiment of the invention.

As illustrated by FIG. 8, and according to an embodiment, the system SYS comprises a device APP for classifying and localizing at least one object OBJ in an image sequence IMG_SEQ and at least one camera CAM. Said at least one camera CAM is configured to capture said one or more images IMG_1, . . . , IMG_N of the sequence IMG_SEQ. In particular, the system SYS comprises, according to a variant, a single camera CAM. The device APP comprises the modules described hereinafter.

The term “module” may just as well be a software component or a hardware component or an assembly of hardware and software components, a software component itself being one or more computer programs or subprograms or more generally any element of a program able to implement a function or a set of functions as described for the modules in question. In this way, a hardware component corresponds to any element of a hardware assembly able to implement a function or a set of functions for the module in question (integrated circuit, chip card, memory card etc.).

As illustrated by FIG. 8, according to a particular embodiment of the invention, the device APP for classifying and localizing at least one object OBJ in an image sequence IMG_SEQ comprises:
an obtaining module MOD_OBT for obtaining a sequence IMG_SEQ of one or more images IMG_1, . . . , IMG_N captured by at least one camera CAM; and
a classifier-localizer module X_NN for determining based on the image sequence IMG_SEQ:
   at least one class ATR_CLAS_OBJ assigned to said at least one object OBJ, said at least one assigned class ATR_CLAS_OBJ being selected from among a list of classes; and
   at least one estimated position EST_POS_OBJ of said at least one object OBJ;
the module being configured based on a reference image sequence to minimize a multi-objective loss function F_LOSS representative both of an objective of classification and of an objective of localization of objects in the reference image sequences TR_DATA.

As illustrated by FIG. 8, and according to a particular embodiment of the invention, the classifier-localizer module X_NN comprises:
an encoder module CNN for determining encoded data LS_DATA based on the image sequence IMG_SEQ;
a classifier module CLA_NN for determining said at least one assigned class ATR_CLAS_OBJ based on the encoded data LS_DATA; and
a localizer module LOC_NN for determining said at least one estimated position EST_POS_OBJ based on the encoded data LS_DATA.

As illustrated by FIG. 8, and according to a particular embodiment of the invention, the obtaining module MOD_OBT comprises:
a capturing module MOD_ACQ for controlling the camera CAM and capturing said one or more images IMG_1, . . . , IMG_N of the sequence IMG_SEQ;
a cropping module MOD_CRP for cropping said one or more images IMG_1, . . . , IMG_N of the sequence IMG_SEQ to center the object OBJ in a determined image IMG_1 of the sequence IMG_SEQ. Typically, the object OBJ is centered on the first image IMG_1 of the cropped sequence IMG_SEQ.

Note that the order in which the steps of a method as previously described follow one another, particularly with reference to the appended drawings, constitutes only an exemplary embodiment without any limitation, variants being possible. Moreover, the reference signs are not limiting of the extent of the protection, their sole function being to simplify the comprehension of the claims.

Those skilled in the art will understand that the embodiments and variants described above constitute only non-limiting examples of implementation of the invention. In particular, those skilled in the art may envision any adaptation or combination of the embodiments and variants described above in order to meet a specific need.

1. A method for classifying and localizing at least one object in an image sequence, said method comprising:
obtaining a sequence of one or more images captured by at least one camera; and
determining, by a classifier-localizer module based on the obtained image sequence:
at least one class assigned to said at least one object, said at least one assigned class being selected from among a list of classes; and
at least one estimated position of said at least one object, said at least one estimated position comprising at least one distance between an observer position and said at least one object;
said classifier-localizer module being configured based on at least one reference image sequence to minimize a multi-objective loss function representative both of an objective of classification and an objective of localization of objects in said at least one reference sequence.

2. The method according to claim 1, wherein said determining comprises:
determining data encoded by an encoder based on the obtained image sequence;
determining said at least one class assigned by a classifier based on the encoded data; and
determining said at least one position estimated by a localizer based on the encoded data.

3. The method according to claim 2, wherein said encoder implements one or more convolutions between the obtained image sequence and a number of filters.

4. The method according to claim 1, wherein said classifier-localizer module comprises a neural network.

5. The method according to claim 1, wherein said one or more images of the obtained sequence are consecutive and wherein the obtaining the image sequence comprises cropping said one or more captured images, one of said objects being centered on a determined image of the sequence.

6. A method for configuring a classifier-localizer module for classifying and localizing objects in image sequences, said method comprising initializing said classifier-localizer module and at least one iteration of the steps of:
determining, by said classifier-localizer module based on at least one reference image sequence:
at least one class assigned to at least one object in said at least one reference sequence, said at least one assigned class being selected from among a list of classes; and
at least one estimated position of said at least one object, said at least one estimated position comprising at least one distance between an observer position and said at least one object;
evaluating a multi-objective loss function on the basis of said at least one assigned class, of said at least one estimated position, of at least one known class and of at least one known position of at least one object in said at least one reference sequence, the multi-objective loss function being representative both of an objective of classification and of an objective of localization of objects;
reconfiguring said classifier-localizer module to minimize the multi-objective loss function.

7. The method according to claim 6, wherein said evaluating the multi-objective loss function comprises:
evaluating a classification loss function based on said at least one assigned class and on at least one known class associated with said at least one object of said at least one reference image sequence;
evaluating a localization loss function based on said at least one estimated position and on at least one known position associated with said at least one object of said least one reference image sequence; and
evaluating the multi-objective loss function based on the result of the classification loss function and on the result of the localization loss function.

8. The method according to claim 7, wherein said classification loss function is evaluated using the expression:
$${L}_{E C} ( {C}_{r} , {p}_{o} ) = - {\sum }_{i = 1}^{M} δ ( {C}_{i} , {C}_{r} ) \cdot ln ( {p}_{o , i} ) ,$$
where L_{EC} is the classification loss function, M is the number of assignable classes of said list of classes, δ(Cᵢ, Cᵣ) is a binary indicator equal to 0 if for a said object the class Cᵢ of said list of classes is different from the known class Cᵣ of said object and otherwise equal to 1, and pₒ=(p_{o,i})_{1≤i≤M} with p_{o,i} a probability determined by the classifier-localizer module that said object belongs to the class Cᵢ.

9. The method according to claim 7, wherein said localization loss function is evaluated using the expression:
$${L}_{IMSE} ( I , {P}_{r} , {P}_{o} ) = \frac{1}{{‖ I ‖}_{1}} {\sum }_{i = 1}^{N} {I}_{i} \cdot {( {P}_{r , i} - {P}_{o , i} )}^{2} ,$$
where L_{IMSE} is the localization loss function, N is the number of images of said at least one reference sequence, I=(Iᵢ)_{1≤i≤N} with ∥I∥₁=Σᵢ|Iᵢ| and Iᵢ a binary indicator equal to 1 if a said object is present in an image of index i of said at least one reference sequence and otherwise equal to 0, Pₒ=(P_{o,i})_{1≤i≤N} with P_{o,i} the estimated position of said object determined by the classifier-localizer module for the image of index i, and Pᵣ=(P_{r,i})_{1≤i≤N} with P_{r,i} the known position of said object for the image of index i.

10. The method according to claim 6, wherein said reconfiguring is performed using a gradient descent algorithm based on the result of the evaluation of the multi-objective loss function.

11. The method according to claim 6, wherein said at least one reference image sequence comprises at least one of the elements of the following group:
one or more images captured by at least one camera; and
one or more synthesized images.

12. The method according to claim 6, comprising several iterations of said determining, evaluating the multi-objective loss function, and reconfiguring the classifier-localizer module.

13. A device for classifying and localizing at least one object in an image sequence, said device comprising:
an obtaining module for obtaining a sequence of one or more images captured by at least one camera; and
a classifier-localizer module for determining, based on the obtained image sequence:
at least one class assigned to said at least one object, said at least one assigned class being selected from among a list of classes; and
at least one estimated position of said at least one object, said at least one estimated position comprising at least one distance between an observer position and said at least one object;
said classifier-localizer module being configured based on at least one reference image sequence to minimize a multi-objective loss function representative both of an objective of classification and of an objective of localization of objects in said at least one reference image sequence .

14. The device according to claim 13 wherein said classifier-localizer module is configured by a configuring method comprising initializing said classifier-localizer module and at least one iteration of the steps of:
determining, by said classifier-localizer module based on the at least one reference image sequence:
the at least one class assigned to at least one object in said at least one reference sequence, said at least one assigned class being selected from among a list of classes; and
the at least one estimated position of said at least one object, said at least one estimated position comprising at least one distance between an observer position and said at least one object;
evaluating the multi-objective loss function on the basis of said at least one assigned class, of said at least one estimated position, of at least one known class and of at least one known position of at least one object in said at least one reference sequence, the multi-objective loss function being representative both of an objective of classification and of an objective of localization of objects;
reconfiguring said classifier-localizer module to minimize the multi-objective loss function.

15. A system comprising a device according to claim 13, and at least one camera configured to capture said one or more images of the sequence.

16. The system according to claim 15, wherein said system is a surveillance system, or a navigation system.

17. An aircraft comprising a system according to claim 15.

18. A non-transitory computer readable medium having stored thereon instructions which, when executed by a processor, cause the processor to implement the steps of a method according to claim 1.

19. A non-transitory computer readable medium having stored thereon instructions which, when executed by a processor, cause the processor to implement the steps of a method according to claim 6.
